(19) United States
(12) Patent Application Publication
(10) Pub. No.: US 2014/0158282 A1
(43) Pub. Date: Jun. 12, 2014

(54) device for the manufacture of a bonded component from fibre-reinforced plastics, and also a method

(71) Applicant: Heinz Bardenhagen, Stade (DE)

(72) Inventor: Heinz Bardenhagen, Stade (DE)

(21) Appl. No.: 14/234,892

(22) PCT Filed: Jun. 27, 2012
(86) PCT No.: PCT/EP2012/064814

§ 371 Date: Jan. 24, 2014

Related U.S. Application Data
(60) Provisional application No. 61/512,006, filed on Jul. 27, 2011.

(30) Foreign Application Priority Data
Jul. 27, 2011 (DE) 10 2011 079 945.1

(51) Int. Cl. B32B 37/00

(52) U.S. Cl. CPC B32B 37/0046
USPC 156/87; 156/349

(57) ABSTRACT

A device and method with at least one base molding tool, at least one release layer and an aeration material, for the manufacture of a bonded component from fiber-reinforced plastic, wherein the bonded component, the aeration material and the release layer are covered with a vacuum envelope sealed with respect to the base molding tool. The aeration material is attached to the base molding tool by at least one fixing element, in particular a Velcro-type tape with hooks or mushroom heads, wherein the fixing element can be repeatably released and attached, and can be used on multiple occasions. The tape with hooks or mushroom heads operating on one or both sides allows for the rapid fixing of location of the aeration material that is necessary within the device. After the completion of the curing process in the autoclave, the aeration material can be released rapidly from the base molding tool.

### CROSS-REFERENCES TO RELATED APPLICATIONS

This application claims the benefit of the U.S. Provisional Application No. 61/512,006, filed on Jul. 27, 2011, and of the German patent application No. 10 2011 079 945.1 filed on Jul. 27, 2011, the entire disclosures of which are incorporated herein by way of reference.

### BACKGROUND OF THE INVENTION

The invention concerns a device with at least one base molding tool, at least one release layer and also an aeration material, for the manufacture of a bonded component from fiber-reinforced plastic, wherein the bonded component, the aeration material, and the release layer are covered with a vacuum envelope, which is sealed with respect to the base molding tool.

For components in which high specific strengths and stiffnesses are required per unit weight, as, for example, in aerospace, fiber-reinforced plastics (FRPs) are often deployed. A fiber-reinforced plastic is a material that is formed from a multiplicity of reinforcing fibers that are embedded in a plastic matrix material. Carbon fibers, glass fibers, aramide® fibers, natural fibers, or similar, are deployed, among others, as the reinforcing fibers. The plastic matrix often consists of thermosetting plastics, such as, for example, epoxy resins, polyester resins, or bismaleimide resins (so-called BMI resin). Fundamentally the bonded components can be manufactured from reinforcing fibers that are already pre-impregnated with the matrix material (so-called prepreg material), and/or with reinforcing fibers that are only infiltrated with the matrix material immediately before the curing process.

The manufacture of components that are formed from fiber-reinforced plastic is undertaken using diverse methods of known art, in which the components are cured with the application of pressure and temperature. For complex components, for which it is not possible to deploy heating presses, molds are used, into which the fiber-reinforced plastics are introduced, as are further elements as required. These molds can be closed so as to surround fully the bonded component, or can be at least partly open. In the case of open molds only one region of the component is defined by the mold surface. The geometrical design of the surface of the component, which does not come into contact with the mold surface, is either free, that is to say, defined only by the covering vacuum generation system, and/or defined with the aid of additional rigid or flexible mold parts. For the curing of the fiber-reinforced plastic the molds are in general heated by an external source. Some molds also have an integral heating system. If the pressures that can be achieved with vacuum generation systems are insufficient, autoclaves are usually deployed. One (or a plurality of) vacuum ports of the mold placed in the autoclave are hereby led out to the external environment, in order that the pressure prevailing in the autoclave becomes fully effective. Vacuum ports can either be integrated into the mold or embodied as a separate element. After the start of the autoclave process the level of vacuum is often reduced, or even switched off, such that normal atmospheric pressure prevails in the region of the vacuum port.

In the case of open molds the pressure required is generally transferred directly onto the fiber-reinforced plastics, i.e., onto the bonded component that is being produced, by means of a vacuum generation system. A vacuum generation system is also used when additional mold parts are deployed; here the pressure is transferred via the mold parts. In addition further elements are necessary within the system for purposes of resin and gas removal, in particular a suitable aeration material.

The essential elements of such a vacuum generation system are the aeration material, a vacuum enveloped, a seal and a vacuum port. A device that is essentially fitted with these elements serves for the isolation of the bonded component from the environment, for the evacuation or ventilation by means of the vacuum port, and for the subsequent curing of the fiber-reinforced plastic with the application of pressure and temperature for the completion of the bonded component that is being manufactured. The aeration material is designed to ensure an even supply of air that is everywhere effective. Furthermore any gases developing during the curing process of the matrix material and any air inclusions arising are led away through the aeration material as required.

The aeration material is also used if the fiber-reinforced plastic, or rather the bonded component, is compacted, i.e., compressed, ahead of the curing process. For the compaction a vacuum is mostly used (a so-called intermediate vacuum). For this purpose a vacuum generation system is used in an analogous manner to that for the curing process. The tear-off material, the resin removal material and the aeration material are preferably manufactured with textile surface structures of glass fibers, nylon fibers and/or polyester fibers. In general a polyester fleece is deployed as the aeration material. As a general rule these elements must be fixed such that their desired position in the vacuum generation system and during the subsequent consolidation is maintained by the pressure forces. At the present time fixing of the elements is mostly undertaken manually by means of adhesive tape. After the curing process the adhesive tape, or rather its residues, must be laboriously removed from the mold surfaces, for example, by manual scraping and/or by the use of solvents.

### SUMMARY OF THE INVENTION

The object of the current invention is therefore to specify a device and a method for the simplified manufacture using molds of complex bonded components from fiber-reinforced plastic, in which in particular the number of adhesive tapes necessary for the fixing of elements is significantly reduced.

In that the aeration material can be attached to the base molding tool by means of at least one fixing element, in particular a Velcro-type tape with hooks or mushroom heads, wherein the fixing element allows for the repeated release and attachment of the aeration material, adhesive tapes, in particular for purposes of securing the location of the aeration material, in the inventive device can to a large extent be eliminated. Suitable Velcro-type tapes with hooks or mushroom heads, made of metal and/or plastic, which can withstand the high temperatures and pressures prevailing in the autoclave, come into consideration as the inventive fixing elements. Furthermore the Velcro-type tapes with hooks or mushroom heads can be provided such that a free passage of gas is possible. In addition to the constituent parts cited the device can have further elements, such as, for example, release layers, matrix removal materials, tear-off films or similar. The release layers can, for example, be formed with release films or with release agents. The bonded component can comprise a multiplicity of optional elements, such as, for example, lightning protection material, core composite materials, fiber-reinforced plastic components that have already been consolidated, such as, for example profiles, fittings, or similar.

In accordance with an advantageous further development of the device provision is made that at least one mold part is arranged within the vacuum envelope.

By this means bonded components can be manufactured from fiber-reinforced plastic in complex spatial geometries, such as, for example, shell parts with integral stiffening elements, in particular stringers. Such reinforced shell parts are deployed, for example, in the manufacture of lifting surfaces, elevator units, vertical tail units and fuselage cells for aircraft. The vacuum envelope can take the form, for example, of a thin film or a mat with a higher material thickness.

In accordance with a further configuration of the device the fixing element is positioned in an edge region of the base molding tool.

This enables a covering over the full surface area of the bonded component that is being produced.

In accordance with a further advantageous configuration of the device the at least one fixing element is arranged in at least some sections in the region of a vacuum channel.

By this means a simplified attachment of the fixing element is possible, because the vacuum channel is usually provided with a perforated covering, which is suitable for the mechanical connection of the at least one fixing element.

In accordance with a further advantageous configuration provision is made that the fixing element is securely connected with the base molding tool.

As a consequence of the fixing elements that are securely connected with the base molding tool, in particular in the form of Velcro-type tapes with hooks or mushroom heads, it is no longer necessary to remove the adhesive tapes, which were previously required for purposes of fixing the elements, by means of laborious mechanical/manual processes and/or chemical solvents from the base molding tool, as a result of which the resource required to manufacture bonded components is significantly reduced at the same time as costs are lowered. At the same time, since the fixing elements can be deployed on multiple occasions, the quantity of waste to be disposed of is greatly reduced, which leads to a further reduction in costs.

In an advantageous further development provision is made that at least one edge covering is connected with the aeration material by means of at least one fixing element.

In particular, sections of the aeration material, which run in the edge region of mold parts, can by this means be thickened so as to protect against any damage, in particular to avoid any damage in the autoclave.

In a further development of the device provision is made that the edge covering and the aeration material are formed from the same material.

By this means the same fixing elements can advantageously be used to secure the location of the aeration material on the base molding tool and to attach the optional edge coverings to the aeration material.

In a further advantageous configuration of the device provision is made that the aeration material is formed from a fleece of plastic fibers, in particular from a polyester fleece that is permeable to gas.

This fleece structure of the aeration material enables an intimate interlocking between the aeration material and the fixing element, which is preferably designed as a Velcro-type tape with hooks or mushroom heads.

In accordance with a further development of the device the fixing element operates on one side and/or on both sides.

A fixing element operating on one side serves for example the purpose of securing the location of the aeration material on the base molding tool, while the fixing element operating on both sides connects, for example, two aeration materials directly with one another in a releasable and repeatable manner.

For the manufacture of a bonded component from fiber-reinforced plastic a base laminate is, for example, laid down on the base molding tool. In a further step of the method reinforcement laminates, e.g., stringer laminates, are positioned on the base laminate with mold parts arranged in between them. Both the base laminate and also the reinforcement laminate can be formed from fiber-reinforced plastics that are pre-impregnated, but not yet cured (so-called prepreg materials). A release layer, a resin removal layer and a tear-off material can, in at least some regions, have been previously arranged underneath the base laminate. The base laminate and the reinforcement laminate can then be covered with further optional tear-off material and with a similarly optional resin removal layer. The total system is then covered with a release layer and an aeration material, the upper face of which is covered over its full surface area with a vacuum envelope. The fixing of the location of the aeration material within the device is undertaken by means of the inventive fixing elements, which are preferably formed as Velcro-type tapes with hooks or mushroom heads, wherein in general the aeration material is a polyester fleece. The vacuum envelope is sealed with respect to the base molding tool by means of a peripheral seal, which surrounds the whole of the bonded component. The whole device is evacuated, at least for some of the time, via a vacuum port, i.e., a vacuum channel, and is then placed in an autoclave for purposes of curing the bonded component under pressure and temperature.

### BRIEF DESCRIPTION OF THE DRAWINGS

In the figure:

FIG. 1 shows a schematic representation of part of a longitudinal section through the device,

FIG. 2 shows a simplified representation of part of a cross-section through the device in the region of the mold parts, and

FIG. 3 shows a schematic representation of part of a cross-section through the device in the region of the mold parts with an alternative form of embodiment for fixing the location of the aeration material.

### DETAILED DESCRIPTION OF THE PREFERRED EMBODIMENTS

In the drawings the same design elements have the same reference numbers in each case.

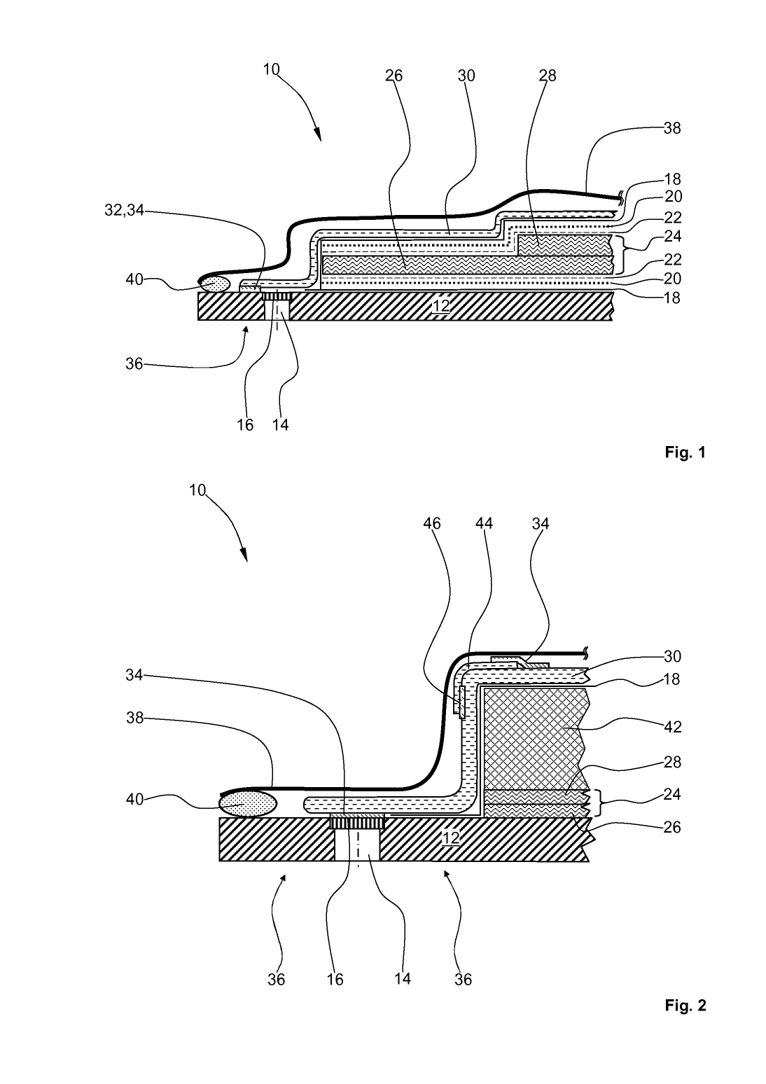

FIG. 1 illustrates a schematic representation of part of a longitudinal section through the inventive device for the simplified manufacture of bonded components with a complex geometry.

The device 10 comprises, among other items, a base molding tool 12 with a vacuum channel 14, i.e., a vacuum port, and a perforated covering 16 that is covering the vacuum channel 14. On the base molding tool 12 are laid down a release layer 18, above this an optional resin removal layer 20, and on this an optional tear-off layer 22. Above the tear-off layer 22 is laid down a bonded component 24, which is formed from fiber-reinforced plastic; this consists of a base laminate 26 and a reinforcement laminate 28, in particular a stringer laminate. In particular carbon fiber-reinforced epoxy resins come into consideration as the fiber-reinforced plastics. The bonded component 24, can, for example, take the form of a spherically curved shell with integrally designed stiffening elements, in particular stringers.

The bonded component 24 is covered with a further optional tear-off layer 22, and a further optional resin removal layer 20. The upper resin removal layer 20 is also covered with an upper release layer 18, which is overlaid with an aeration material 30 for purposes of removing any gases that may develop, as well as any air inclusions arising. The aeration material 30 is preferably formed from a polyester fleece that is permeable to gas, which in accordance with the invention is attached in an edge region 36 of the base molding tool 12 by means of a fixing element 32, in particular by means of a Velcro-type tape 34 with hooks or mushroom heads. The edge region 36 essentially defines that part of the surface, here not designated, of the base molding tool 12, which is not overlaid with the base laminate 26 or the reinforcement laminate 28. The Velcro-type tape 34 with hooks or mushroom heads is itself, in the example of embodiment shown here, attached outboard of the perforated covering 16 on the base molding tool 12, but in a variation from this arrangement can also be positioned in other regions of the edge region 36 and can have a smaller or a larger surface area extent. The Velcro-type tape 34 with hooks or mushroom heads is connected with the base molding tool 12 by means of suitable connecting technology, which can withstand the extreme conditions in an autoclave. For example it can be connected with the molding tool 12 by means of adhesive, clamping, caulking, crimping, riveting, screwing, or by means of a releasable form fit connection, i.e., the Velcro-type tape 34 with hooks or mushroom heads is, e.g., in the manner of piping, pressed into a groove with a correspondingly undercut cross-sectional geometry. The Velcro-type tape 34 with hooks or mushroom heads can moreover be provided throughout the edge region 36 of the base molding tool 12, or only in some sections. Fundamentally the Velcro-type tape 34 with hooks or mushroom heads is arranged in the edge region of the base molding tool 12, at least in some regions, i.e., in some sections.

The fixing of the aeration material 30 to the base molding tool 12 with the aid of adhesive tapes in devices of prior known art that has thus far been necessary for the manufacture of components from fiber-reinforced plastics is eliminated. The Velcro-type tape 34 with hooks or mushroom heads interlocks with the polyester fleece of the aeration material 30, as a result of which an intimate connection ensues, but one which when necessary can be repeatedly released and remade—in a similar manner to Velcro fasteners of known art. The aeration material 30 is finally fully covered by a vacuum envelope 38, i.e., by a vacuum mat, which is sealed with respect to the base molding tool 12 by means of a seal 40.

For purposes of curing the bonded component 24 the device 10 is subjected to a reduced pressure via the vacuum channel 14 and is then placed in an autoclave in which curing takes place under pressure and temperature. During the curing of the bonded component 24 in the autoclave the vacuum underneath the vacuum envelope 38 is often switched off, so that just the normal atmospheric ambient air pressure is present in the region of the vacuum port, i.e., the vacuum channel 14.

After completion of the curing process the bonded component 24 can be taken out of the device. Here the Velcro-type tape 34 with hooks or mushroom heads enables in particular the simple and rapid removal of the aeration material 30 from the base molding tool 12. The removal and disposal of any adhesive residues of the adhesive tapes previously deployed for purposes of fixing the location of the aeration material 30 can be eliminated in the inventive device 10 without any substitution, which leads to a significant saving in time and cost.

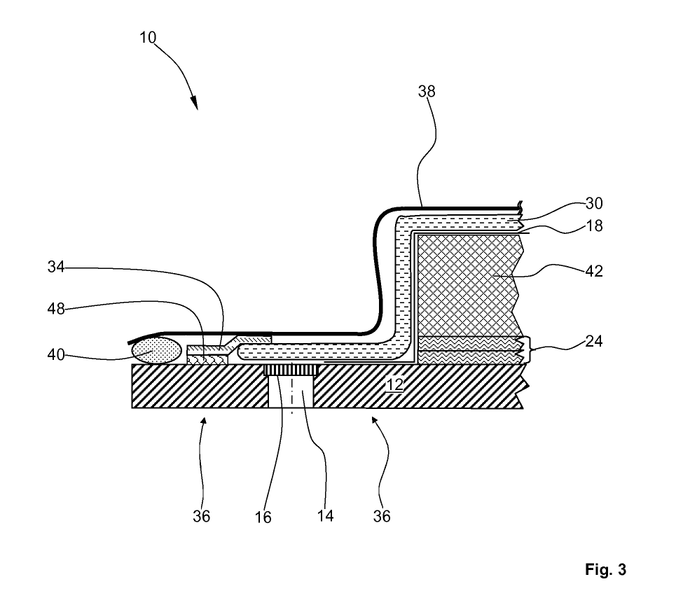

FIG. 2 shows a representation of part of a cross-section through the device in the region of the mold parts.

In a variation from FIG. 1 the base laminate 26 and the reinforcement laminate 28, which together represent the bonded component 24, lie directly on the base molding tool 12, i.e., here no separate release layer 18 is provided underneath the bonded component 24. In contrast to FIG. 1 a complete mold part 42, provided with a release layer (not represented) also lies on the reinforcement laminate 28; this serves to define the shape of a stiffening element, not represented, such as, for example a stringer designed integrally with the base laminate 26. The mold part 42 is provided with a release layer 18, which for its part is covered with the aeration material 30. With the aid of the elastic seal 40 the vacuum envelope 38 is hermetically sealed with respect to the base molding tool 12. The fixing of the location of the aeration material 30 in the edge region 36 of the base molding tool 12 is undertaken in turn by means of the one-sided Velcro-type tape 34 with hooks or mushroom heads, which, in a deviation from the representation in FIG. 1, is attached directly to the perforated covering 16 of the vacuum channel 14 and covers the full surface of the latter. The attachment of the Velcro-type tape 34 with hooks or mushroom heads is undertaken by means of a connecting technology that has already been addressed further above. In the case of this arrangement of the Velcro-type tape 34 with hooks or mushroom heads the latter must have a sufficient permeability to gas, such that a sufficiently high level of vacuum can be generated underneath the vacuum envelope 38 via the vacuum channel 14. Independently of the spatial arrangement of the Velcro-type tape 34 with hooks or mushroom heads in the edge region 36 of the base molding tool 12, this is produced from a material that is in a position to withstand durably the extreme pressure and temperature conditions usually prevailing in an autoclave. Fundamentally the Velcro-type tape 34 with hooks or mushroom heads can be produced from a metallic material and/or a plastic material. The same is true for the base molding tool 12 and the mold part 42. The base molding tool 12 and the mold part 42 are often formed from aluminum alloys. The base molding tool 12 can also be produced from metal alloys that have a low thermal expansion coefficient, such as Invar®, for example. The mold part 42 can in individual cases also be formed from plastic materials that have sufficient temperature resistance.

The Velcro-type tape 34 with hooks or mushroom heads for fixing the location of the aeration material 30, shown in an exemplary manner in FIGS. 1, 2, operates on only one side, i.e., only the upper side of the tape interlocks with the aeration material 30 of polyester fleece, while the lower side of the Velcro-type tape 34 with hooks or mushroom heads must be connected with the base molding tool 12 using an alternative method of attachment.

In the representation of FIG. 2 furthermore an edge region, not designated, of the mold part 42 is provided with an edge covering 44, which preferably is formed form the same material, in particular with the polyester fleece that also serves for the manufacture of the aeration material 30. The edge covering 44, among other properties, is designed to avoid any damage to the vacuum envelope 38, to the aeration material 30, and to any other layers present as a consequence of the relatively sharp-edged mold part 42 at high pressure in the autoclave. The fixing of the location of this edge covering 44 can be undertaken either with the Velcro-type tape 34 with hooks or mushroom heads operating on one side, as already described, and/or with a Velcro-type tape 46 with hooks or mushroom heads operating on both sides.

Here the Velcro-type tape 46 with hooks or mushroom heads operating on both sides has the particular advantage that it can be positioned directly between the edge covering 44 and the aeration material 30 without leading to any significant increase in thickness, because it presses slightly into the aeration material 30 and the edge covering 44. In contrast the one-sided Velcro-type tape 46 with hooks or mushroom heads leads under some circumstances to an undesirable thickening in an overlapping region, not designated, between the edge covering 44 and the aeration material 30.

FIG. 3 corresponds essentially to the representation of the device in accordance with FIG. 2, but shows an alternative form of embodiment for the edge-side attachment of the aeration material.

The bonded component 24 is laid down on the base molding tool 12, here provided with a release layer, not represented. Above the bonded component 24 is located the mold part 42, provided complete with a release layer, together with the release layer 18 that runs over the mold part, and which in turn is covered by the aeration material 30. The whole system is surrounded by the vacuum envelope 38, which is sealed with respect to the base molding tool 12 by means of the seal 40, A space, not designated, between the vacuum envelope 38 and the base molding tool 12 can be subjected to a reduced pressure via the vacuum channel 14 with the therein accommodated perforated covering 16. Here a right-hand side flange section, not designated, of the Velcro-type tape 34 with hooks or mushroom heads is connected with the textile aeration material 30, while a left-hand side flange section of the Velcro-type tape 34 with hooks or mushroom heads is connected with the base molding tool 12 via a so-called Velcro-type tape 48 with loops, or another textile surface structure. Between the two flange sections there exists a slight vertical displacement, i.e., a small step. The Velcro-type tape 48 with loops for its part is attached to the base molding tool 12 by means of one of the methods of attachment elucidated in the introduction. In a variation from the two previous forms of embodiment this attachment variant does not require any direct connection of the Velcro-type tape 34 with hooks or mushroom heads to the edge region 36 of the base molding tool, which as a rule is metallic, or to the perforated covering 16.

In a deviation from the prior art, the inventive device uses Velcro-type tapes 34, 46 with hooks or mushroom heads for a Velcro-type connection that can be reversibly used to fix the location of the aeration material 30, which is necessary in particular for purposes of removal of resin and gas within the device 10, and by this means makes possible a significantly reduced level of deployment of materials and resources. The use of the Velcro-type tapes 34, 46 with hooks or mushroom heads by this means reduces the cost for the device 10, the cleaning costs for the molding tools and the expenditures arising in conjunction with the fixing, i.e., attachment, materials.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-10. (canceled)

11. A device for the manufacture of a bonded component from fiber-reinforced plastic, comprising:
at least one base molding tool,
at least one release layer, and
an aeration material,
the bonded component, the aeration material and the release layer being covered with a vacuum envelope, which is sealed with respect to the basemolding tool,
the aeration material being attached to the base molding tool by means of at least one fixing element,
the fixing element allowing for the repeated release and attachment of the aeration material.

12. The device in accordance with claim 11, wherein the fixing element comprises a tape with at least one of a hooks and mushroom heads.

13. The device in accordance with claim 11, wherein at least one mold part is arranged within the vacuum envelope.

14. The device in accordance with claim 11, wherein the fixing element is positioned in an edge region of the base molding tool.

15. The device in accordance with claim 11, wherein the at least one fixing element is arranged in the region of a vacuum channel, in at least some sections.

16. The device in accordance with claim 11, wherein the fixing element is securely connected with the base molding tool.

17. The device in accordance with claim 11, wherein at least one edge covering is connected with the aeration material by means of at least one fixing element.

18. The device in accordance with claim 11, wherein the edge covering and the aeration material are formed from the same material.

19. The device in accordance with claim 11, wherein the aeration material is formed from a fleece of plastic fibers.

20. The device in accordance with claim 19, wherein the fleece of plastic fibers comprises a polyester fleece that is permeable to gas.

21. The device in accordance with claim 11, wherein the fixing element operates on at least one side.

22. A method for the manufacture of a bonded component with fiber-reinforced plastic, in particular using the device in accordance with one of the claim 11.
